(19) United States
(12) Patent Application Publication
(10) Pub. No.: US 2026/0217615 A1
(43) Pub. Date: Jul. 30, 2026

(54) Stable and Self-Leveling Bonded Seal

(71) Applicant: Knauf Gips KG, Iphofen (DE)

(72) Inventors: Sven Zinssler, Sennfeld (DE); Petar Djordjevic, Beograd (RS); Djordje Andjelkoski, Beograd (RS); Aleksandar Pesic, Beograd (RS)

(21) Appl. No.: 19/141,085

(22) PCT Filed: Dec. 22, 2022
(86) PCT No.: PCT/EP2022/025590

§ 371 Date: Jun. 19, 2025

(51) Int. Cl. C04B 40/00; C04B 14/06; C04B 14/10; C04B 14/28; C04B 24/26; C04B 103/32; C04B 103/44; C04B 111/27; C04B 111/62; C04B 111/70

(52) U.S. Cl. CPC C04B 40/0042; C04B 14/06; C04B 14/104; C04B 14/28; C04B 24/2647; C04B 2103/32; C04B 2103/44; C04B 2111/275; C04B 2111/62; C04B 2111/70; C04B 2201/10

(57) ABSTRACT

The present invention is concerned with a two or multi component composition with a powder component A and a liquid component B, which includes a hydraulic binding agent in the powder component A, a HASE thickener in the liquid component B and a superplasticizer. The HASE thickener and superplasticizer are provided in given ratio, for use as a stable and self-levelling bonded seal. The present invention is further concerned with cementitious compositions, which are obtained by mixing the components of the inventive two or multi component composition, the use of the respective compositions for the waterproofing of vertical or horizontal surfaces and methods for the application of respective cementitious compositions.

### CROSS-REFERENCE TO RELATED APPLICATION

This application is the United States national phase of International Patent Application No. PCT/EP2022/025590 filed Dec. 22, 2022, the disclosure of which is hereby incorporated by reference in its entirety.

### BACKGROUND OF THE INVENTION

### Field of the Invention

The present invention is concerned with a two or multi component composition with a powder component A and a liquid component B, which comprises a hydraulic binding agent in the powder component A, a HASE thickener in the component B and a superplasticizer, wherein the HASE thickener and superplasticizer are provided in given ratio, for use as a stable and self-levelling bonded seal. The present invention is further concerned with cementitious compositions, which are obtained by mixing the components of the inventive two or multi component composition, the use of the respective compositions for the waterproofing of vertical or horizontal surfaces and methods for the application of respective cementitious compositions.

### Description of Related Art

In the state of the art, there are yet only products which provide for a stable texture so that they can be applied to walls, and products which have self-leveling properties, so that these products, when applied to a substrate, from an even surface.

Regular stable one or two component cementitious bonded seals (i.e. for application by trowel, spreading or rolling) have been state of the art for a long time and are in the product portfolio of many producers in construction chemistry. Most of the currently available stable bonded seals are based on one or two component mixtures. These can be applied to a wall or on a floor, and are high viscosity compositions to prevent them from flowing of dripping from the surface, to which they have been applied.

As different use, where similar cementitious compositions are used, is a self-leveling application, where the composition is spread on a horizontal surface such as a floor and the compositions form an even surface via the impact of gravity. Such compositions are also often used in construction and there are numerous commercial products with self levelling properties. Most often, these products are in solid form, from which the self levelling composition is prepared by addition of water and mixing.

Flooring compounds have to fulfill numerous requirements. Among them, the requirement of compression resistance as well as flexural strength and pressure resistance can be mentioned, which allow the floor to resist the stresses caused by heavy objects such as furniture or people walking on the floor and the like. Also the formation of cracks due to shrinkage during hardening is to be avoided.

For flooring compounds, an important application is drainage of old cellars since this makes it possible to use these rooms for higher-value purposes, such as living-rooms or bedrooms. Old cellars are often loaded with moisture and frequently have very uneven ground floors made of rammed concrete, old brick or soil. For these applications, it is especially important to prevent rising damp, i.e. the capillary rise of liquid water through the floor. Another type of rooms, where watertightness (or waterproofing) is of high importance is bathroom walls and floor, where there is a risk of overflowing bath tubs and water may frequently be sprayed onto wall e.g. in a shower.

For respective flooring application, EP 3 932 888 A1 describes a watertight self-levelling flooring compound, which is prepared from a fresh mortar comprising a hydraulic binder, aggregates, a minor quantity of a hydrophobic agent in the form of e.g. alkylalkoxysilanes and/or silicon resins, where a defined quantity of air is incorporated into the mortar. The respective composition is formulated as a one component dry mortar, from which the self-leveling mortar is prepared via addition of water.

A commercial one-component mortar, which is available for floor applications, is Ardex S8 flow.

A problem of these solutions in the art is, that for each application there is a specialized product, which has the downside that a number of different products have to be provided on the construction site. Also, it frequently happens that a once opened product has to be fully prepared, even if only some minor amount of the product is required (due to partial hardening of cementitious powder compositions, which come into contact with atmospheric moisture), in which case the unused product may have to be discarded. To avoid excessive production of waste, there is thus a drive towards more universal solutions, where construction products can be used for different applications depending on the needs at the construction site. In particular, a product would be desirable, which depending on the need can be used for water proofing of both walls and floors (where self-leveling is demanded), so that the product can be used in a flexible manner both applications. Here, the main problem for these different uses is that they require significantly different viscosities and that conventional products are optimized for their intended application.

### SUMMARY OF THE INVENTION

In the investigations, which are underlying the present invention, it has unexpectedly been found that a combination of a superplasticizer and a HASE thickener (i.e. a hydrophobically-modified alkali soluble emulsion based thickeners) allows for the formulation of a composition which is stable upon application to a vertical surface (i.e. it does not drip and stays on the surface where it is applied withstanding gravitational forces), but which by addition of water can be converted to a self levelling composition with a viscosity, which allows for the formation of a flat surface during the open time of the composition. While no particular theory is relied upon, it is believed that the addition of water compromises the thixotropic structure of the HASE thickener, so that the thickening effect thereof is minimized to result in a significant drop in the viscosity despite of the fact that only a low amount of water is added thereto. To provide the desired balance of properties for a stable consistency and sufficient self levelling properties (without significant impact on the properties of the resulting hardened product), the key functional ingredients of the HASE thickener and superplasticizer are incorporated in a specific ratio.

Accordingly, in a first aspect, the invention concerns a two or multi component composition comprising a powder component A and a liquid component B, wherein the powder component comprises an hydraulic binding agent and the liquid component B comprises a hydrophobically-modified alkali soluble emulsion (HASE) as a thickener, wherein the component A or B comprises a superplasticizer, and wherein the thickener and the superplasticizer are present in the composition in a ratio of from 5:1 to 1:2.

For the superplasticizer, it is not important whether it is incorporated into the powder component A or the liquid component B. For formulation purposes and insurance of the activity of the superplasticizer on the hydraulic binder (where homogeneous distribution with the binder is necessary), it is preferred that the superplasticizer is incorporated into the powder component A.

Since the superplasticizer and the HASE thickener are highly active compounds, it is regularly sufficient (and from an economic standpoint advisable) that these are incorporated into the two or multi component composition in low amounts, i.e. with a combined amount of less than 3% based on the total weight of the two or multi component composition. Preferably, the content of the superplasticizer and the HASE thickener is in the range of 0.01 to 1.0 wt.-% and more preferably 0.1 to 0.8 wt.-%.

The superplasticizer is not subject to any relevant restriction, as long as the component provides the mixture of hydraulic binding agent and other constituents with the required flowability for the self-levelling properties at low water/cement ratios. Preferably however, the superplasticizer is a polycarboxylate superplasticizer, and more preferably a polycarboxylate ether. Particularly preferably, the superplasticizer is comb polymer comprising a polycarboxylate backbone with polyether side chains attached thereto. Respective superplasticizers can e.g. be obtained under the trade name Viscocrete from Sika Deutschland GmbH.

The HASE thickener is likewise not subject to any relevant restriction, except that the thickening properties thereof should be sufficiently susceptible to the addition of water. Particularly suitable HASE thickeners are polymers comprising acrylate ester and unsaturated carboxylic acid moieties and especially HASE thickeners which comprise 45 to 60 weight percent structural units of alkyl acrylate (preferably in the form of C1-6-acrylates), and from 32 to 65 weight percent structural units of methacrylic acid and/or acrylic acid. Next to these monomers, further monomers or monomers with macromolecular groups, in particular with a hydrophobic part or moiety, can be incorporated into the HASE thickener. As noted above, the HASE thickener is a constituent of the liquid composition, where it is not harmful however, if small quantities of the thickener are also included in the powder component.

The HASE thickener may include from 0.01 to 1 weight percent of units of a cross-linking agent, which is typically a diethylenically unsaturated compound such as divinyl benzene, allyl methacrylate, diallyl phthalate, trimethylol propane triacrylate, 1,6-hexanediol diacrylate, ethylene glycol diacrylate or dimethacrylate. The HASE thickener preferably has a weight average molecular weight Mw ranging from 10,000 to several million Daltons.

The molecular weight of the HASE thickener may be controlled by a chain transfer agent at a level preferably from 0.05 to 5 percent by weight, based on the weight of total monomers, to obtain relatively low molecular weight HASEs, which in some instances has been found to be advantageous. Examples of suitable chain transfer agents include hydroxyethyl mercaptan, β-mercaptopropionic acid, and C4-C22-alkylmercaptans such as n-dodecylmercaptan.

The powder component A of the inventive two or more component composition comprises one or more hydraulic binding agents and preferably in addition one or more aggregates.

A hydraulic binding agent is a substantially inorganic or mineral material or blend, which hardens when mixed with water. Hydraulic binders also encompass latent hydraulic binders or pozzolanic binders which usually requires activation, e.g. by the presence of lime, in order to show hydraulic properties. All hydraulic binders known to those skilled in the art are suitable.

Typical examples of hydraulic binders are at least one of cement, e.g. Portland cement, fly ash, granulated blast furnace slag, lime, such as limestone and quicklime, rice husk, calcined paper sludge, fumed silica and pozzolana or a mixture thereof. The hydraulic binder preferably comprises cement, in particular Portland cement. Hydraulic binders such as cement often include in addition calcium sulphate, such as gypsum, anhydrite and hemihydrate.

In a preferred embodiment, the powder component A comprises at least Ordinary Portland Cement (OPC) as a cementitious binder. Suitable OPC is, for example, classified as CEM I under standard DIN 197-1. However, other OPC classified, for example, under the relevant ASTM, JIS or Chinese standards is also suitable.

In the practice of the invention it is possible to use blended cements as cementitious binder in the powder component A, such as Portland composite cement (CEM II), blast furnace cement (CEM III), pozzolanic cement (CEM IV) and composite cement (CEM V) according to DIN 197-1 in addition to OPC. It is further possible, to use special cements, such as calcium sulfoaluminate cement, calcium aluminate cement, or mixtures thereof in addition to the OPC.

The content of the hydraulic binder in the powder composition is advantageously in a range of from 10 to 40 wt.-% and more preferably a range of from 20 to 35 wt.-%, based on the total weight of the powder component A.

The powder component suitably further comprises one or more aggregates. Aggregates are chemically inert, solid particulate materials. Aggregates come in various shapes, sizes, and materials ranging from fine particles of sand to large, coarse rocks. Examples of suitable aggregates are sand, such as silica sand, gravel, and crushed stone, slag, calcined flint, lightweight aggregates such as clay, pumice, perlite, bentonite and vermiculite. Sand, in particular silica sand, is preferably used to reach the workability expected and to obtain a smooth surface.

The grain size of the aggregates may vary depending on the application, but is preferably rather small, e.g. not more than 6 mm, preferably not more than 4 mm. The aggregate may have, for instance, a grain size in the range of 0.05 to 4 mm, preferably 0.1 to 3 mm, wherein sand, in particular silica sand/quartz sand, having a grain size in the range of 0.1 to 3 mm, is particularly preferred. For instance, sand having a grain size ranging from 0.1 to 0.3 mm can be advantageously used in the present invention. The grain size range can be determined, e.g. by sieve analysis. Further suitable aggregates for use in the invention include limestone, e.g. with an average particle size of 0.25 mm.

The content of the aggregates is not particularly limited, but it is preferred that the aggregates account for the major proportion of the powder component. In one preferred embodiment, the amount of aggregates in the powder component is in the range of 50 to 85 wt.-% of the total weight of the powder component and in a particularly preferred embodiment, the aggregates account for 60 to 80 wt.-% of the powder component A.

To provide the inventive two or multi component composition with advantageous water proofing properties, it is expedient that the liquid component B comprises a major portion of a water emulsifyable organic polymer, which on curing of the composition increases the hydrophobicity of the construction and impedes the passage of water from an upper surface through the construction. A water emulsifyable organic polymer, which in the practice of the present invention has turned out to be particularly suitable for this purpose, is a polymer having ethylene and vinyl acetate moieties and in particular a polymer having ethylene, vinyl acetate and further vinyl ester moieties. Such polymer is usually incorporated into the liquid component B in larger quantities such as in an amount of at least 25 wt.-%, based on the total weight of the liquid composition B, where contents of from 30 to 65 wt.-% and preferably of from 40 to 60 wt.-% have proven to be particularly effective. To form the liquid component B, the polymer is regularly formulated with water, so that in most cases the total water content in the liquid component B will be in the range of from 25 to 50 wt.-%.

The two or more component composition of the invention may optionally comprise one or more additives, which are commonly used, and are typically known to the persons skilled in the art of cementitious applications. Examples of suitable additives, which may be optionally used in the powder component are oil, such as mineral oil, paraffin oil and organic oil, cellulose fibers, and inorganic or organic pigments, rheology modifiers and air void formers. Depending on whether these additives are solid or liquid in pure form, they are suitably included into the component with the same state of aggregation.

The powder component A and the liquid component B are preferably provided in an amount in the two or more component composition that the powder composition is at the same level or higher than the amount of the liquid compositions. In this manner, it is ensured that there is no relevant excess of water while at the same time the composition on mixing of the components has suitable consistence/sufficient flowability for processing thereof. In one embodiment, the ratio of the powder component A to the liquid component B is from 4.5:1 to 2:1 and in a particularly preferred embodiment, the ratio is from 4:1 to 2.5:1.

As noted above, it is of advantage for the two or more component composition of the invention that the water content therein is limited, as thus there is no relevant excess of water which may delay the curing of the composition or which requires that larger amounts of HASE thickener have to be used in the composition to provide the intended “stable” unsupported composition on mixing of the components of the composition. In terms of the water/cement ratio, it is thus preferred that this ratio in the whole composition is adjusted to a range of from 0.5 to 0.9. More preferably, the water/cement ratio is in the range of 0.54 to 0.8 and even more preferably in the range of from 0.56 to 0.7.

As a third component, the two or more component composition can comprise a water component, which is regularly constituted to the predominant amount of water and in most cases is water in the form of e.g. tap water. As also with the addition of water as a third component it is intended to keep the water content in the composition at a low level, water as a third component is preferably used in an amount of 3 to 10 wt.-% and more preferably in an amount of 4 to 8 wt.-% based on the combined amount of the components in such multi component composition.

The water, which is used as a third component can either be provided in a kit or set with three containers for each of the powder component A, the liquid component B and the third water component, or can be provided as a set of only powder component A, the liquid component B and instructions, on how much water is to be added to the composition from another source (e.g. a tap). In one preferred embodiment, the two or more component composition is a composition of the latter type with instructions to either only mix the two components A and B of the composition or to add a given amount of water from another water source for the mixing.

As has been noted previously, the two or more component composition of the invention is usually processed by mixing of the respective components into a homogeneous mixture, so that in a further aspect, the present invention concerns a cementitious composition obtained by intimately/homogeneously mixing the components of the two or multi component composition as described above. Here, the term “cementitious” is to be understood as a composition which comprises a hydraulic binder as a constituent thereof, which after mixing of the composition eventually hardens to form a cured composition (and is not limited to compositions, which comprise “cement” in a conventional understanding such as e.g. cement of the types CEM I to CEM V). Preferably, however, the cementitious composition comprises a cement of the types CEM I to CEM V and in particular comprises Ordinary Portland cement.

Upon mixing of the components of the two or more component composition of the invention, it is preferred that the mixture (prior to curing/hardening) has a dynamic viscosity as measured by Brookfield DVE rotational viscometer of from 15000 to 25000 mPa·s (at 22° C. and 50% relative humidity), more preferably of from 16000 to 22000 mPa·s and even more preferably of from 17000 to 19500 mPa·s. Such viscosity is preferred for an application of the composition as a “stable” unsupported grout. Accordingly, the present invention is also concerned with the use of a respective cementitious composition as an unsupported grout, and preferably as an unsupported waterproofing grout (where in most instances a water emulsifyable organic polymer will be incorporated into the composition), wherein the cured grout is water impermeable according to DIN EN 14891:2012 (i.e. no water penetration and less than 20 g mass gain at water pressure of 150 kPa for 7 days).

Alternatively, it is preferred that the mixed cementitious composition has a dynamic viscosity as measured by Brookfield DVE rotational viscometer of 1000 to 5000 mPa·s, preferably of from 2000 to 4000 mPa·s. Such viscosity is preferred for an application of the composition as a self-levelling grout or screed. Accordingly, the present invention is also concerned with the use of a respective cementitious composition as a self-levelling grout or screed, and preferably as a self levelling grout or screed (which in most cases would be formulated with a water emulsifyable organic polymer in the composition).

In a yet further aspect, the present invention is concerned with the use of a of a cementitious composition with self levelling properties as noted above for decoupling of a substrate from an upper construction or for compensating unevenness in a vertical or horizontal surface. For the latter case, the construction is a construction with an uneven surface, such as an uneven floor. In the case of the use for decoupling, the substrate can be a floor formed from an old or new concrete, ceramic tiles or other hard materials without dust, which has been degreased and primed with appropriate primer. The upper construction can be another flooring finish such as ceramic or vinyl tiles, which are bonded with an appropriate adhesive.

In a yet further aspect, the present invention is concerned with a method for processing a two or multi component composition as described above, which comprises the steps:
mixing the components two or multi component composition to form a homogeneous mixture,
applying the mixture to a vertical surface, or
applying the mixture to a horizontal surface and allowing the mixture to self level,
allowing the mixture to harden.

In case the mixture is applied to a vertical surface it is preferred that the application is by means of a trowel, such as an even or toothed trowel. Further, it is preferred that after the mixture has been applied on the vertical surface a tile is applied subsequently applied thereon.

### DESCRIPTION OF THE INVENTION

In the following, the invention will be further illustrated by means of examples, which should however not be construed as limiting the invention thereto.

### EXAMPLES

### Example 1

A liquid and a powder component were formulated according to the list of ingredients as shown in the following table 1.

TABLE 1

in parts by wt.

Powder component

| | |
|---|---|
| Quartz sand 0.1-0.3 mm | 541 |
| Rheology modifier | 3 |
| Portland cement CEM I 52.5 R | 250 |
| Reductant with limestone flour | 2 |
| Limestone fraction 0.25 | 200 |
| Superplasticizer | 3 |
| Air void former | 1 |

Liquid component

| | |
|---|---|
| Tap water | 20 |
| Bactericide, fungizide | 10 |
| HASE plasticizer | 6 |
| Aqueous polymer emulsion on the basis of | 960 |
| Vinylacetate-Ethylen-Vinylester (59% solid content) | |
| Na/K methylsiliconate | 4 |

The above liquid component had a viscosity of 1988 mPa·s, a density of 1.02 and a pH of 7.17.

The respective compositions were mixed in a ratio of 3:1 (powder component/liquid component) for formulation of a stable unsupported mixture and in a ratio of 3:1:0.21 (powder component/liquid component/water) to form a self-levelling composition.

The respective viscosities of these compositions, as well as the consistency as determined by flow table test according to EN 1015-3 with 15 strokes or free flow Vicat cup after 3, 15, 25 and 30 Min are given in the following table 2.

TABLE 2

| | | |
|---|---|---|
| | Consistency/ | Consistency/free flow |
| Viscosity | 15 strokes | Vicat cup at 3/15/25/30 |
| [mPa · s] | [cm] | Min [cm]¹ |

Mixing ratio 3:1

| | | |
|---|---|---|
| Sample 1 | 18330 | 17 |
| Sample 2 | 17000 | 16.7 |
| Sample 3 | 19400 | 17 |
| Sample 4 | 17000 | 17.7 |

Mixing ratio 3:1:0.21

| | | |
|---|---|---|
| Sample 5 | 2400 | 23.3/22.8/22.2/22 |
| Sample 6 | 2493 | 23/22.3/22/21.5 |
| Sample 7 | 2360 | 23.7/23/22.4/22.1 |
| Sample 8 | 2300 | 23.5/22.4/21.6/21.6 |

¹= Vicat cup is a standard cup of fixed dimensions used for determining setting times with Vicat apparatus. In this case, it is used as a constant volume for determining the flow diameter. To this end, the cups are filled to top and after 3, 15, 25, and 30 minutes cups are lifted to allow for free flow of the material. After that the largest diameter of the filling is determined.

In the above, the viscosity is determined by Brookfield DVE rotational viscometer at conditions 7/60/30% for samples 1 to 4 and Apr. 30, 1940% for samples 5 to 8, where the first number indicates the spindle for a DVE Brookfield viscosimeter, the second number indicated the speed in rpm and the last number indicates the load (e.g. “30%”) of the spindle. The viscosity is determined at 22° C. at 50 relative humidity.

As is apparent from table 2, the composition had suitable properties for application as a stable unsupported mortar and self-levelling screed.

### Example 2

The bond strength, crack bridging capability and water impermeability was tested according to DIN EN 14891. For testing the bond strength, the respective composition were applied to a substrate (Solana 30×40) and cured for 28 days under standard, water, heat and freeze thaw conditions. The compositions, that were used for the tests were as described in example 1, where next to the 3:1 and 3:1:0.21 a composition with a water content of 0.3 was used. These compositions in the following will be referred to as compositions I (3:1), II (3:1:0.21) and III (3:1:0.3).

The bond strength of the cured compositions after 28 days are given in the below table 3. In all cases, the damage was cohesion failure within the applied composition:

TABLE 3

| | Bond strength [N/mm²] | | |
|---|---|---|---|
| | compositions I | compositions II | compositions III |
| 28 d standard | 0.6 | 0.97 | 0.98 |
| 28 d water | 0.44 | 0.75 | 0.96 |
| 28 d heat | 0.86 | 1.16 | 1.06 |
| 28 d freeze thaw | 0.57 | 0.99 | 0.99 |

In addition, the crack bridging capability according to DIN EN 14891 was determined for the compositions at temperatures of 23° C. and −5° C.

The results of these tests are given in the following table 4.

TABLE 4

Crack bridging [mm]

| | compositions I | compositions II | compositions III |
|---|---|---|---|
| 23° C. | 0.493 | 0.452 | 0.408 |
| −5° C. | 0.950 | 0.597 | 0.380 |

Finally, the water permeation was determined according to DIN EN 14891 after 7 days at a pressure of 1.5 bar. For this test, three samples A, B and C were used for each of the compositions I, II and III. The results of these tests are given in the following table 5.

TABLE 5

Penetrated water [mm] after 7 d

| | compositions I | compositions II | compositions III |
|---|---|---|---|
| A | 75 | 0 | 0 |
| B | 200 | 0 | 0 |
| C | 0 | 0 | 0 |

As can be seen from the above tables 3 to 5, the bond strength and water proofing properties are slightly better for the compositions, which are formulated with more water, which may be a result of the higher density of the cured composition II and III (about 1.7 g/cm³) relative to composition I (about 1.4 g/cm³). On the other hand, the lower density formulation has better crack bridging properties. Nonetheless, since the water amount observed for sample B in composition I is low (200 ml), the composition is still adequate for use as a water proofing wall cover.

1. A two or multi component composition comprising a powder component A and a liquid component B, wherein the powder component comprises a hydraulic binding agent and the liquid component B comprises a hydrophobically-modified alkali soluble emulsion (HASE) as a thickener, wherein the component A or B comprises a superplasticizer, and wherein the thickener and the superplasticizer are present in the composition in a ratio of from 5:1 to 1:2.

2. The two or multi component composition according to claim 1, which comprises a combined amount of hydrophobically-modified alkali soluble emulsion as a thickener and superplasticizer of 0.01 to 1.0 wt.-% and preferably 0.8 to 0.1 wt.-%.

3. The two or multi component composition according to claim 1, wherein the superplasticizer is a polycarboxylate, preferably a polycarboxylate ether and even more preferably a comb polymer comprising a polycarboxylate backbone with polyether side chains attached thereto.

4. The two or multi component composition according to claim 1, wherein the thickener is based on a polymer comprising acrylate ester and unsaturated carboxylic acid moieties, preferably wherein the thickener comprises 45 to 60 weight percent structural units of alkyl acrylate, and from 32 to 65 weight percent structural units of methacrylic acid and/or acrylic acid.

5. The two or multi component composition according to claim 1, wherein the powder component A contains cement as the hydraulic binding agent, and/or wherein the amount of the hydraulic binding agent is from 10 to 40 wt.-% and preferably from 20 to 35 wt.-%, based on the total weight of the powder component A.

6. The two or multi component composition according to claim 1, wherein the liquid component B contains a water emulsifyable organic polymer, preferably having ethylene and vinyl acetate moieties, in an amount of from 30 to 65 wt.-% and more preferably of from 40 to 60 wt.-% and/or water in an amount of from 25 to 50 wt.-%.

7. The two or multi component composition according to claim 1, wherein the powder component A further comprises one or more particulate aggregates, preferably including one or more of sand, limestone and bentonite, wherein the amount of the aggregates is preferably in the range of from 50 to 85 wt.-% and more preferably of from 60 to 80 wt.-%, based on the total weight of the powder component A.

8. The two or multi component composition according to claim 1, wherein the ratio of the powder component A to the liquid component B is from 5:1 to 1:1 and preferably form 4:1 to 2.5:1.

9. The two or multi component composition according to claim 1, wherein the composition comprises water as a third component, wherein preferably the third component accounts for 3 to 10 wt.-% and more preferably for 4 to 8 wt.-% of the combined amount of the components in the two or multi component composition.

10. A cementitious composition obtained by intimately mixing the components of the two or multi component composition according to claim 1.

11. The cementitious composition according to claim 10, wherein the composition has a dynamic viscosity as measured by Brookfield DVE rotational viscometer of from 15000 to 25000 mPa·s, preferably form 16000 to 22000 mPa·s and even more preferably of from 17000 to 19500 mPa·s, where the viscosity is determined by a Brookfield viscosimeter with spindle No. 7 at a speed of 60 rpm and 30% spindle load at 22° C., 50% relative humidity.

12. The cementitious composition according to claim 10, wherein the composition has a dynamic viscosity as measured by Brookfield DVE rotational viscometer of 1000 to 5000 mPa·s, preferably of from 2000 to 4000 mPa·s, where the viscosity is determined by a Brookfield viscosimeter with spindle No. 4 at a speed of 30 rpm and 40% spindle load at 22° C., 50% relative humidity.

13. An unsupported waterproofing grout, which preferably is water impermeable according to DIN EN 14891:2012, comprising a cementitious composition according to claim 11.

14. A self-leveling waterproofing grout, which preferably is water impermeable according to DIN EN 14891:2012, comprising a cementitious composition according to claim 12.

15. A method for decoupling of a substrate from an upper construction or for compensating unevenness in a vertical or horizontal surface, comprising a step of providing a cementitious composition according to claim 12.

16. A method for processing a two or multi component composition according to claim 1, which comprises the steps:
mixing the components two or multi component composition to form a homogeneous mixture,
applying the mixture to a vertical surface, or
applying the mixture to a horizontal surface and allowing the mixture to self level,
allowing the mixture to harden.
